(19) United States
(12) Patent Application Publication
(10) Pub. No.: US 2025/0136178 A1
(43) Pub. Date: May 1, 2025

(54) TURNING CONTROLLER

(71) Applicant: DENSO CORPORATION, Kariya-city (JP)

(72) Inventors: TAKAFUMI SATO, Kariya-city (JP); YUTA SUZUKI, Kariya-city (JP)

(21) Appl. No.: 19/001,787

(22) Filed: Dec. 26, 2024

Related U.S. Application Data
(63) Continuation of application No. PCT/JP2023/022014, filed on Jun. 14, 2023.

(30) Foreign Application Priority Data
Jun. 28, 2022 (JP) 2022-103551

(51) Int. Cl. B62D 7/15

(52) U.S. Cl. CPC B62D 7/159

(57) ABSTRACT

A turning controller in a vehicle controls turning of each wheel using independent turning actuators for three or more wheels that are not mechanically connected. The vehicle also features a steering command device for automated driving or a steer-by-wire system, which is separated from the turning actuators. The turning controller includes a generator that creates a final steering command value based on signals from the steering mechanism or the steering command device. A calculator within the turning controller then determines a turning angle command value for each wheel, considering the vehicle's speed; higher speeds result in reduced turning angles. Controllers for each turning actuator regulate the driving current to ensure the turning angle matches the command value.

### CROSS REFERENCE TO RELATED APPLICATIONS

The present application is a continuation application of International Patent Application No. PCT/JP2023/022014 filed on Jun. 14, 2023, which designated the U.S. and claims the benefit of priority from Japanese Patent Application No. 2022-103551 filed on Jun. 28, 2022. The entire disclosures of all of the above applications are incorporated herein by reference.

### TECHNICAL FIELD

The present disclosure relates to a turning controller.

### BACKGROUND

Conventional steering devices are known to determine a target turning angle for each of multiple independent steering mechanisms in a steer-by-wire system.

### SUMMARY

According to at least one embodiment, a turning controller controls turning of each wheel in a vehicle. The vehicle is equipped with turning actuators that independently steer three or more wheels. These wheels are not mechanically coupled to each other. The vehicle also has a steering command device for automated driving or a steering mechanism of a steer-by-wire system. The steer-by-wire system is mechanically separated from the turning actuators. The turning controller includes a generator. The generator generates a final steering command value. This value is based on a steering angle signal output from the steering mechanism or a steering command value from the steering command device. The turning controller also includes a calculator. The calculator calculates a turning angle command value for each wheel. This calculation is based on the final steering command value and the vehicle speed. As the vehicle speed increases, the turning angle is reduced with respect to the final steering command value. Controllers are provided for each turning actuator. Each controller controls the driving current supplied to its corresponding turning actuator. This ensures that the turning angle output by the turning actuator follows the turning angle command value. The calculator performs its calculations such that the higher the vehicle speed, the more the turning angle is reduced with respect to the final steering command value.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic diagram of an independently turning vehicle to which a turning controller according to an embodiment is applied.

FIG. 2 is a diagram illustrating a turning operation according to Ackermann steering geometry.

FIG. 3 is a diagram illustrating setting example 1 of a vehicle turning center according to vehicle speed.

FIG. 4 is a diagram illustrating a relationship between a steering angle and the vehicle speed and a turning center setting distance.

FIG. 5 is a diagram illustrating example 2 of setting the vehicle turning center according to the vehicle speed.

FIG. 6 is a diagram illustrating example 3 of setting the vehicle turning center according to the vehicle speed.

FIG. 7 is a flowchart of a turning angle command value calculation process.

FIG. 8 is a diagram illustrating a turning operation according to parallel steering geometry.

### DETAILED DESCRIPTION

To begin with, examples of relevant techniques will be described.

Conventional steering devices are known to determine a target turning angle for each of multiple independent steering mechanisms in a steer-by-wire system. For example, a high-level ECU of a steering device in a comparative example includes a turning angle determination unit that calculates a target turning angle of left and right turning mechanisms based on a steering angle detected by a steering angle sensor. A relationship between the steering angle and the target turning angle is shown in a map.

Vehicle behavior may change significantly in response to small steering commands when turning at high vehicle speed, and a driver and passengers may feel uncomfortable if a steering angle command value corresponding to a steering angle and an automatic steering command value is the same regardless of vehicle speed. In the comparative example steering device, characteristics of the target turning angle relative to the steering angle may vary depending on the vehicle speed. However, the steering device in the comparative example targets only vehicles with left and right steering wheels, that is, two wheels independently steering, and does not consider the behavior of vehicles with three or more independent steering wheels, including four-wheel independently steering vehicles.

In contrast to the comparative example, according to a turning controller of the present disclosure, a vehicle can be operated stably when turning at high vehicle speeds in an independently turning vehicle having three or more wheels.

According to one aspect of the present disclosure, a turning controller controls turning of each wheel in a vehicle. The vehicle is equipped with turning actuators that independently steer three or more wheels. These wheels are not mechanically coupled to each other. The vehicle also has a steering command device for automated driving or a steering mechanism of a steer-by-wire system. The steer-by-wire system is mechanically separated from the turning actuators. The turning controller includes a generator. The generator generates a final steering command value. This value is based on a steering angle signal output from the steering mechanism or a steering command value from the steering command device. The turning controller also includes a calculator. The calculator calculates a turning angle command value for each wheel. This calculation is based on the final steering command value and the vehicle speed. As the vehicle speed increases, the turning angle is reduced with respect to the final steering command value. Controllers are provided for each turning actuator. Each controller controls the driving current supplied to its corresponding turning actuator. This ensures that the turning angle output by the turning actuator follows the turning angle command value. The calculator performs its calculations such that the higher the vehicle speed, the more the turning angle is reduced with respect to the final steering command value.

The turning controller is capable of stabilizing the vehicle operation when turning at high vehicle speeds. By reducing abrupt steering when turning at the high vehicle speeds, a driver and a passenger discomfort can be reduced.

A turning controller according to one embodiment will be described with reference to the accompanying drawings. The turning controller of the present embodiment controls a turning of each wheel in a vehicle (four-wheel independently steering vehicle) in which four wheels that are not mechanically restricted from one another can be turned independently.

### First Embodiment

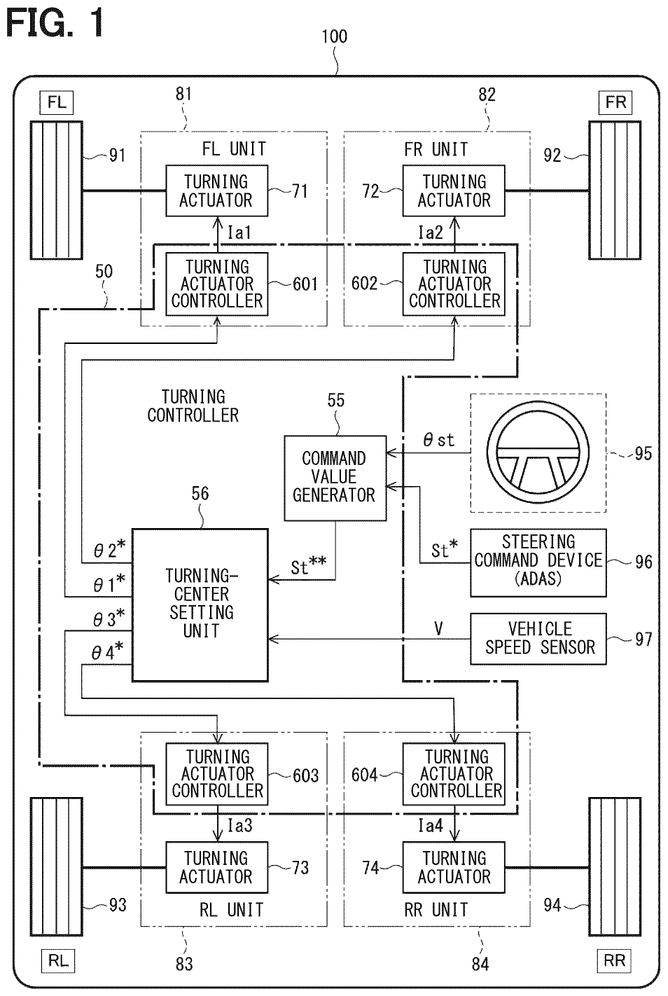

As shown in FIG. 1, a configuration of an independently turning vehicle 100 to which a turning controller 50 of a first embodiment is applied is described. Four wheels 91 to 94 of the vehicle 100 are not mechanically constrained to each other and can be steered independently. A front left wheel 91 is defined as “FL”, a front right wheel 92 is defined as “FR”, a rear left wheel 93 is defined as “RL”, and a rear right wheel 94 is defined as “RR”. For example, each of the wheels 91 to 94 is a drive wheel equipped with an in-wheel motor, and can be independently turned and independently driven.

Four turning actuators 71 to 74 turn the wheels 91 to 94. For example, the turning actuators 71 to 74 of the present embodiment are configured with a dual-system three-phase brushless motor having two redundant winding sets. Four turning actuator controllers 601 to 604 are provided corresponding to the four turning actuators 71 to 74. The turning actuators 71 to 74 and the turning actuator controllers 601 to 604 are operated by receiving a power supply voltage from an in-vehicle battery (not shown).

In the present embodiment, the vehicle 100 is also equipped with both a steering mechanism 95 of a steer-by-wire system, which is mechanically separate from the turning actuators 71 to 74, and a steering command device 96 of automated driving. In other embodiments, the vehicle 100 may be equipped with only one of the steering mechanism 95 or the steering command device 96.

A steering wheel 95 is typically used as the steering mechanism for steer-by-wire systems, but other steering mechanisms such as joysticks may be used. A steering angle signal θst is output when the driver operates the steering wheel 95 in manual operation. The steering command device 96 is realized by ADAS (Advanced Driver Assistance System), for example, and outputs a steering command value St1 (St*) according to a route to a destination and road conditions.

The turning controller 50 has a command value generator 55, a turning-center setting unit 56, and the turning actuator controllers 601 to 604.

The command value generator 55 generates a final steering command value St2 (St**) based on the steering angle signal θst output by the steering wheel 95 and the steering command value St1 output by the steering command device 96. Here, the steering command value St1 and the final steering command value St2 are basically assumed to be angular dimension values equivalent to the steering angle. A torque dimension value may be used, for example, as an angular correlation quantity. The steering angle signal θst, the steering command value St1, and the final steering command value St2 are defined to be 0 when the vehicle 100 is moving straight ahead and take positive or negative values depending on a steering direction relative to a neutral position. For example, a left turn is represented by a positive value and a right turn by a negative value.

The final steering command value St2 is a quantity that is adjusted in consideration of a priority level between manual and automatic operation. In a situation where the manual driving is mainly performed by the driver and the automated driving system assists in steering, a contribution ratio of the steering angle signal θst is set to be high. The contribution ratio of the steering command value St1 is set higher during driving assistance such as lane keep assist. The steering angle signal θst is switched to be given priority when steering torque whose absolute value exceeds a predetermined value is input by the driver's intention during driving assistance.

The final steering command value St2 is input to the turning-center setting unit 56 from the command value generator 55, and vehicle speed V is input from a vehicle speed sensor 97 of the vehicle 100. The turning-center setting unit 56 sets a vehicle turning center C based on the final steering command value St2 and the vehicle speed V. The details will be described later. The turning-center setting unit 56 calculates the turning angle command values θ11 (θ1*) to θ41 (θ4*) for each wheel 91 to 94 from the vehicle turning center C. In other words, the turning-center setting unit 56 functions as the “turning angle command value calculator” by calculating the turning angle command values θ11 to θ41 for each wheel 91 to 94 via the vehicle turning center C based on the final steering command value St2 and the vehicle speed V.

The turning actuator controllers 601 to 604 control driving current Ia1 to Ia4 through the turning actuators 71 to 74 so that the turning angle output by the turning actuators 71 to 74 follows the turning angle command value θ11 to θ41. The turning angle is defined, for example, so that a left side is positive and a right side is negative with respect to a neutral position. In the following description, a term “maximum turning angle” refers to a turning angle whose absolute value is maximum, regardless of reference numerals.

A set of a turning actuator and a turning actuator controller corresponding to each of the wheels 91 to 94 is referred to as a unit. A turning actuator 71 and a turning actuator controller 601 constitute an FL unit 81 corresponding to the front left wheel 91. A turning actuator 72 and a turning actuator controller 602 constitute an FR unit 82 corresponding to the front right wheel 92. A turning actuator 73 and a turning actuator controller 603 constitute an RL unit 83 corresponding to the rear left wheel 93. A turning actuator 74 and a turning actuator controller 604 constitute an RR unit 84 corresponding to the rear right wheel 94.

Each unit may be configured as an electromechanically integrated turning module in which the turning actuator and the turning actuator controller are integrated together. In this case, the turning module may further be configured integrally with the wheels. Alternatively, each unit may have a separate turning actuator and a turning actuator controller electrically connected by wiring.

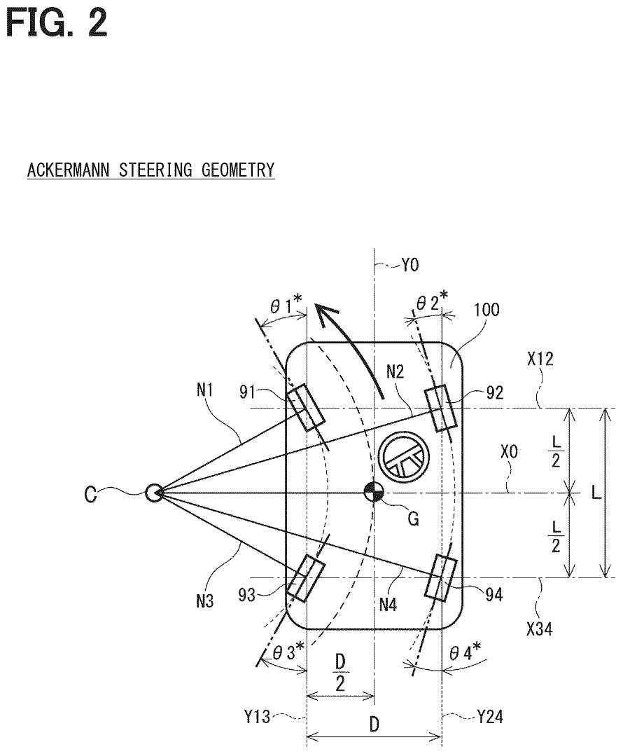

In the present embodiment, the turning-center setting unit 56 sets the vehicle turning center C so that each wheel 91 to 94 has a turning motion according to Ackermann steering geometry. As shown in FIG. 2, a relationship between the vehicle turning center C and the turning angle command values θ11 to θ41 based on Ackermann theory is explained. According to Ackermann theory, the turning direction of each of the wheels 91 to 94 is perpendicular to straight lines N1 to N4 connecting the vehicle turning center C and the center of each of the wheels 91 to 94. That is, each of the wheels 91 to 94 is steered in the tangent direction of a circle having the vehicle turning center C as its center. A turning angle ratio of the turning angle of the outer wheel to the turning angle of the inner wheel is less than 1.

The turning-center setting unit 56 of the present embodiment calculates the turning angle command values θ11 to θ41 for each wheel 91 to 94 from the vehicle turning center C based on Ackermann theory. An axis passing through the centers of the front wheels 91, 92 and perpendicular to a vehicle longitudinal axis Y0 is defined as a front wheel axis X12, and an axis passing through the centers of the rear wheels 93, 94 and perpendicular to the vehicle longitudinal axis Y0 is defined as a rear wheel axis X34. The distance between the front wheel axis X12 and the rear wheel axis X34 is a wheelbase L.

Further, an axis passing through the center of gravity G and perpendicular to the vehicle longitudinal axis Y0 is represented as a gravity axis X0. Assuming that weight distribution in a vehicle front-rear direction is uniform, the gravity axis X0 is located midway between the front wheel axis X12 and the rear wheel axis X34. When the vehicle turning center C is set on the gravity axis X0, the front left wheel 91 and the rear left wheel 93, and the front right wheel 92 and the rear right wheel 94 each turn on the same arc, so that an inner wheel difference and an outer wheel difference become zero and a running resistance during turning becomes small.

Additionally, an axis passing through a centers of the front and rear wheels on the same left-right side of the vehicle is defined as a front-rear wheel axis. An axis passing through centers of the front left wheel 91 and the rear left wheel 93 is represented as a left-front-rear wheel axis Y13, and an axis passing through centers of the front right wheel 92 and the rear right wheel 94 is represented as a right-front-rear wheel axis Y24. A distance between the left-front-rear wheel axis Y13 and the right-front-rear wheel axis Y24 is a tread width D. The left-front-rear wheel axis Y13 and the right-front-rear wheel axis Y24 are symmetrical with respect to the vehicle longitudinal axis Y0, and a distance between the left-front-rear wheel axis Y13 and the vehicle longitudinal axis Y0, and a distance between the right-front-rear wheel axis Y24 and the vehicle longitudinal axis Y0 are both expressed as (D/2).

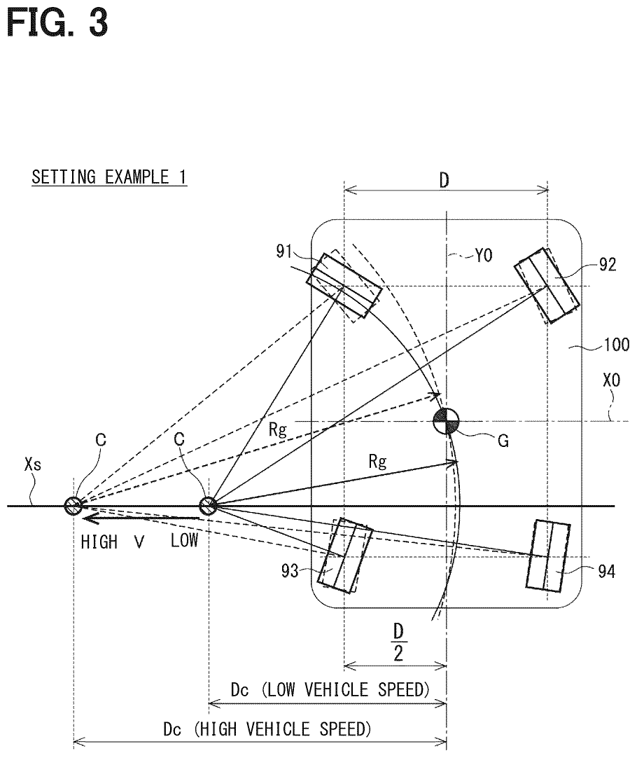

As shown in FIGS. 3 to 6, a specific example in which the turning-center setting unit 56 sets the vehicle turning center C according to the vehicle speed V is explained. The turning-center setting unit 56 sets the vehicle turning center C so that the higher the vehicle speed V is, the more the steering is reduced relative to the final steering command value St2, and calculates the turning angle command values θ11 to θ41 for each wheel 91 to 94. Each FIGS. 3 to 6 shows an example of a left turn, that is, a sign of the steering angle is positive. The same is basically true for right turns, except that the sign of the steering angle is negative.

In setting example 1 shown in FIG. 3, one setting axis Xs is defined, which is orthogonal to the vehicle longitudinal axis Y0. FIG. 3 shows an example where the setting axis Xs is set on the rear wheel side from the gravity axis X0, but the setting axis Xs may be set on the gravity axis X0 or on the front wheel side from the gravity axis X0. For example, a position of the setting axis Xs is determined by whether reduction of discomfort is more important for the driver or the front seat passenger or the rear seat passenger.

Here, a distance from the vehicle longitudinal axis Y0 to the vehicle turning center C is defined as a “turning center setting distance Dc”. The vehicle turning center C is set on the left-front-rear wheel axis Y13 when the front left wheel 91 is steered +90 degree and the rear left wheel 93 is steered −90 degree. In this case, the turning center setting distance Dc is “D/2”, which is a minimum value Dc_min. The minimum value Dc_min of the turning center setting distance is greater than “D/2” when the maximum turning angle is less than ±90 degree.

The turning center setting distance Dc is theoretically infinite when the vehicle 100 is moving straight ahead and the turning angle of each wheel 91 to 94 is 0 degree. The turning center setting distance Dc corresponding to a minimum resolution turning angle is recognized as a maximum value Dc_max of a realistic turning center setting distance when starting to steer from the straight ahead state. The turning-center setting unit 56 sets the vehicle turning center C on the setting axis Xc while manipulating the turning center setting distance Dc so that the higher the vehicle speed V is, the larger the turning center setting distance Dc is in a range from the minimum value Dc_min to the maximum value Dc_max.

Each wheel 91 to 94 at low speed and a line connecting the vehicle turning center C and the center of each wheel 91 to 94 are shown as solid lines. Each wheel 91 to 94 at high vehicle speed and a straight line connecting the vehicle turning center C and the center of each wheel 91 to 94 are shown as dashed lines. The higher the vehicle speed V is, the farther the vehicle turning center C is from the vehicle longitudinal axis Y0, and the larger the turning radius Rg from the vehicle turning center C to the center of gravity G. Thus, steering during turning is reduced.

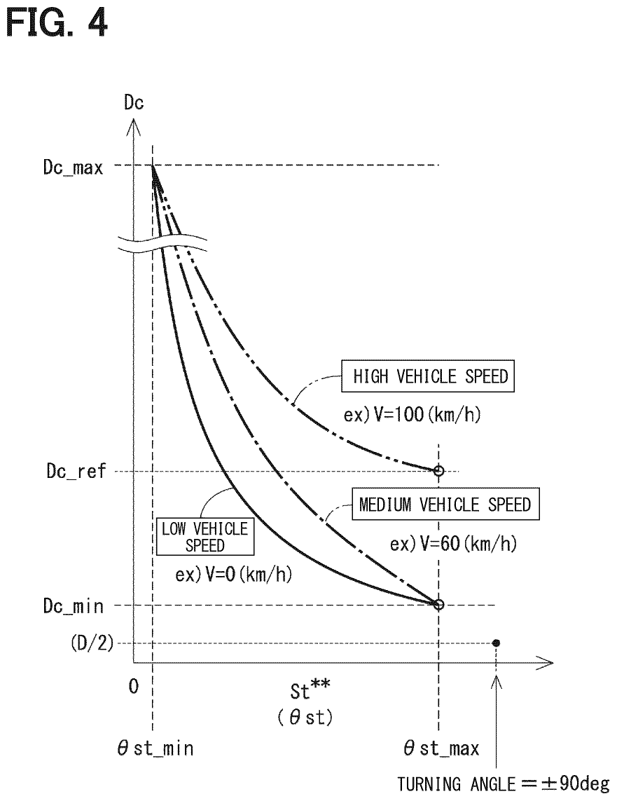

FIG. 4 shows a three-dimensional map that specifies a relationship between the final steering command value St2 and the turning center setting distance Dc for multiple vehicle speeds V. The turning-center setting unit 56 determines the turning center setting distance Dc using this three-dimensional map. Here, the term “map” is not limited to a large number of data groups stored in a readable manner, but also includes calculation formulas. In other words, outputting the calculation result of a formula based on input variables is also considered to be one form of calculation using a map.

A horizontal axis of the map in FIG. 4 is the final steering command value St2, but assuming that the steering angle signal θst is mainly input from the steering wheel 95, the horizontal axis of the map is explained as the steering angle θst for convenience. A vertical axis of the map is the turning center setting distance Dc, which ranges from the minimum value Dc_min to the maximum value Dc_max. Characteristic lines for low (for example, 0 km/h), medium (for example, 60 km/h), and high (for example, 100 km/h) vehicle speeds are marked with solid, dash-dot-dash, and two-dot chain lines, respectively, as the multiple vehicle speeds V.

The “minimum resolution steering angle” is denoted as “minimum steering angle θst_min”. The turning center setting distance Dc at low vehicle speed varies from the maximum value Dc_max corresponding to a minimum steering angle θst_min to the minimum value Dc_min corresponding to a maximum steering angle θst_max. The characteristic that the turning center setting distance Dc decreases rapidly from the maximum value Dc_max is expressed as “the falloff slope is steep” when the steering angle θst starts to increase from the minimum steering angle θst_min in the low speed range. As the vehicle speed V increases, the falling slope becomes more gradual. In other words, tendency is toward understeer, in which the steering is reduced in relation to the steering.

For example, in the medium speed range of 60 km/h, the falling slope is more gradual than in the low speed range, but the turning center setting distance Dc corresponding to the maximum steering angle θst_max is set to the same value as the minimum value Dc_min in the low speed range. Thus, for example, in the speed range below 60 km/h, the maximum turning angle is achieved when the driver steers to the maximum.

In contrast, for example, in the high speed range of 100 km/h, the turning center setting distance Dc corresponding to the maximum steering angle θst_max is set to a reference value Dc_ref, which is greater than the minimum value Dc_min. Here, in a conventional vehicle with mechanically coupled left and right wheels, the theoretical turning center setting distance should be the same as the minimum value Dc_min, because the wheels turn as much as the steering wheel is steered. However, at high vehicle speeds, the tires slide, so the realistic turning center setting distance is greater than the minimum value Dc_min. The reference value Dc_ref of the present embodiment is about the same as the realistic turning center setting distance for a conventional vehicle. Therefore, in the present embodiment, at least the same level of “steering-to-steering” response as that of a conventional vehicle is ensured even at high vehicle speeds.

Thus, the turning-center setting unit 56 of the present embodiment sets the vehicle turning center C according to the vehicle speed V and calculates the turning angle command values θ11 to θ41 for each wheel 91 to 94 from the vehicle turning center C, so there is no need to create a turning angle command value map for each wheel. Thus, the four wheels 91 to 94 can be controlled in a simplified manner.

In particular, in setting example 1 of the vehicle turning center C, since the turning center setting distance Dc is operated according to the vehicle speed V on one setting axis Xs, a steering feeling similar to that of a conventional vehicle with mechanically coupled left and right wheels is realized.

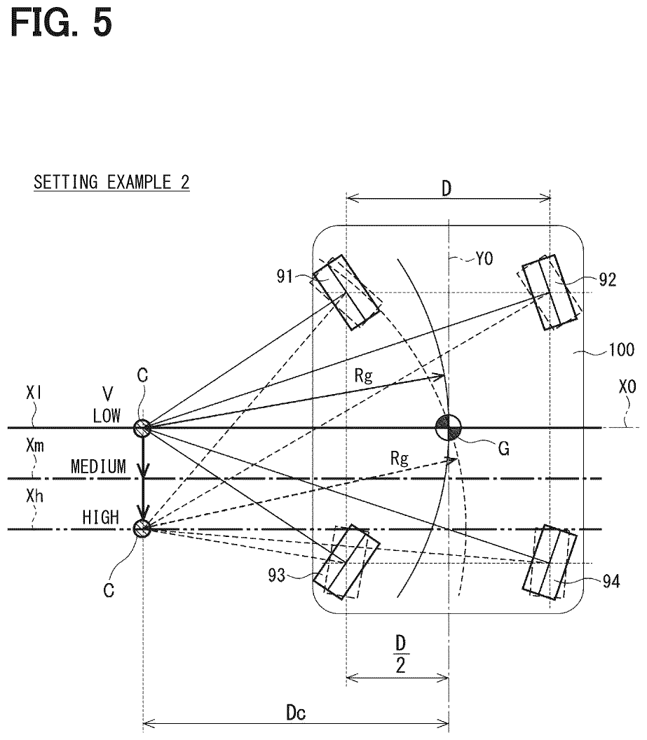

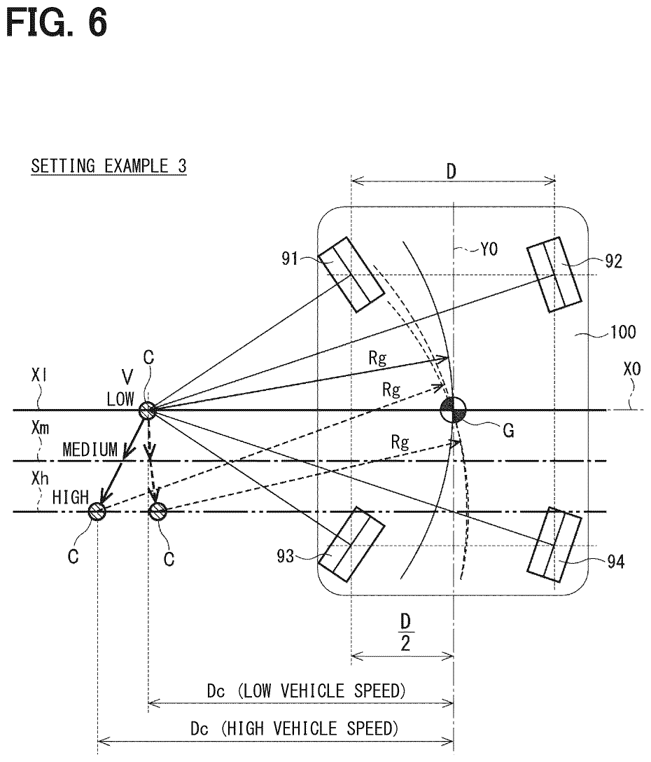

Next, in setting examples 2, 3 shown in FIGS. 5, 6, multiple setting axes Xl, Xm, Xh are defined that are orthogonal to the vehicle longitudinal axis Y0. The turning-center setting unit 56 sets the vehicle turning center C on one of the setting axes while manipulating the turning center setting distance Dc, which is a distance from the vehicle longitudinal axis Y0 to the vehicle turning center C. The turning-center setting unit 56 changes the setting axis that sets the vehicle turning center C according to the vehicle speed V. The turning-center setting unit 56 determines the turning center setting distance Dc for the setting axis using the three-dimensional map that specifies the relationship between the final steering command value St2 and the turning center setting distance Dc for multiple vehicle speeds V.

In setting examples 2, 3 shown in FIGS. 5, 6, three setting axes Xl, Xm, Xh are defined for low vehicle speed, medium vehicle speed, and high vehicle speed. In FIGS. 5, 6, the setting axis Xl for the low vehicle speed is illustrated on the gravity axis X0, the setting axis Xm for the medium vehicle speed is illustrated on the rear wheel side more than the setting axis Xl for the low vehicle speed, and the setting axis Xh for the high vehicle speed is illustrated further rear than the setting axis Xm for the medium vehicle speed. Not limited to this position, only the setting axis Xl for the low vehicle speed may be set to the front wheels side of the gravity axis X0, or all setting axes Xl, Xm, Xh may be set to the front wheels side of the gravity axis X0. Other notes regarding the illustrations in FIGS. 5, 6 are the same as in FIG. 3. In setting examples 2, 3, basically the same 3D map as in FIG. 4 is used for each setting axis.

In setting example 2 shown in FIG. 5, the setting axis of the vehicle turning center C is changed according to the vehicle speed V, but the turning center setting distance Dc corresponding to the same steering angle (strictly speaking, the final steering command value St2) at each setting axis is set constant. As vehicle speed V increases, the vehicle turning center C moves from the gravity axis X0 to the rear wheels, parallel to the vehicle longitudinal axis Y0. The higher the vehicle speed V is, the larger the turning radius Rg from the vehicle turning center C to the center of gravity G becomes, which reduces steering. In this case, when looking at the left and front right wheels 91, 92 individually, the turning angle at the high vehicle speed is greater than the turning angle at the low vehicle speed, but the overall vehicle turning angle is reduced.

In setting example 3 shown in FIG. 6, the setting axis of the vehicle turning center C is changed according to the vehicle speed V, and the turning center setting distance Dc corresponding to the same steering angle (strictly speaking, the final steering command value St2) at each setting axis. FIG. 6 omits the dashed lines illustration of each wheel 91 to 94 at the high speed. As the vehicle speed V increases, the vehicle turning center C moves from the gravity axis X0 to the rear wheels at an angle to the vehicle longitudinal axis Y0. In this case, the vehicle turning center C may move outward, that is, away from the vehicle longitudinal axis Y0, as shown by the solid arrow. As shown by the dashed arrow, the vehicle turning center C may move inward, that is, closer to the vehicle longitudinal axis Y0, as long as the turning radius Rg increases.

In setting examples 2, 3, in addition to the effects of setting example 1, the vehicle turning center C can be set on the understeer side where the vehicle behavior becomes more stable as the vehicle speed V increases by changing the setting axis according to the vehicle speed V.

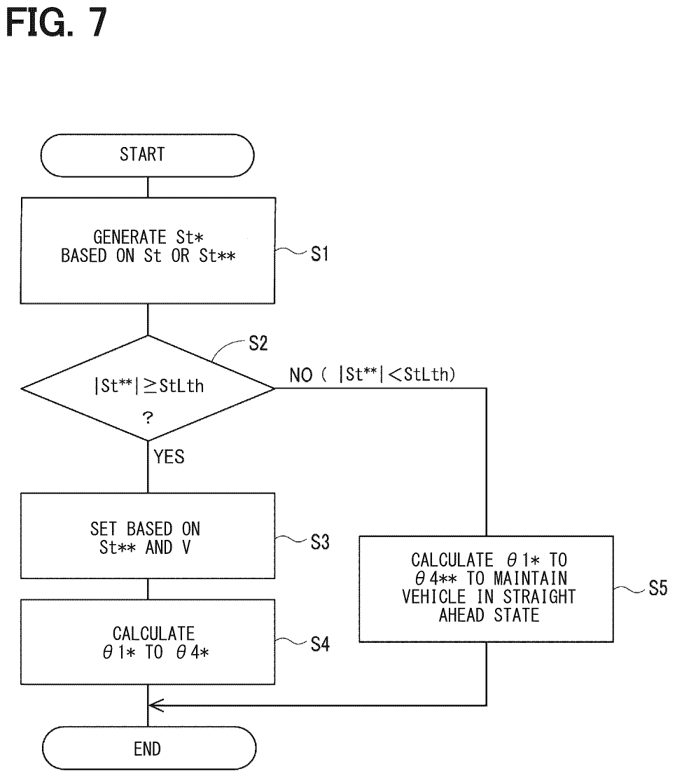

Referring to a flowchart in FIG. 7, the turning angle command value calculation process according to the present embodiment is explained. In the following flowchart, a symbol S indicates a step. In step S1, the command value generator 55 generates the final steering command value St2 based on the steering angle signal θst output by the steering wheel 95 or the steering command value St1 generated by the steering command device 96.

In step S2, it is determined whether an absolute value of the final steering command value |St2| is greater than or equal to a steering lower limit threshold value StLth. If YES in step S2, the process proceeds to step S3. In step S3, the turning-center setting unit 56 sets the vehicle turning center C based on the final steering command value St2 and the vehicle speed V. In step S4, the turning-center setting unit 56 calculates the turning angle command values θ11 to θ41 for each wheel 91 to 94 from the vehicle turning center C.

If NO in step S2, that is, the absolute value of the final steering command value |St2| is less than the steering lower threshold value StLth, the turning-center setting unit 56 in step S5 calculates the turning angle command values θ11 to θ41 for each wheel 91 to 94 to maintain the vehicle 100 in the straight ahead state. In other words, a range where the absolute value of the final steering command value |St2| is smaller than the steering lower limit threshold StLth is treated as a steering dead zone. Thus, stability at the high vehicle speeds is ensured.

As described above, the turning controller 50 of the present embodiment is capable of stabilizing the vehicle operation when turning at the high vehicle speeds. By reducing abrupt steering when turning at the high vehicle speeds, the driver and passenger discomfort can be reduced.

The conventional comparative example is intended only for vehicles with two independent left and right steering wheels, and does not consider the behavior of four-wheel independently steering vehicles. In contrast, in the present embodiment the turning controller 50 can appropriately set the vehicle turning center C of the four-wheel independently steering vehicle 100 and calculate the turning angle command values θ11 to θ41 for each wheel 91 to 94.

### Other Embodiments

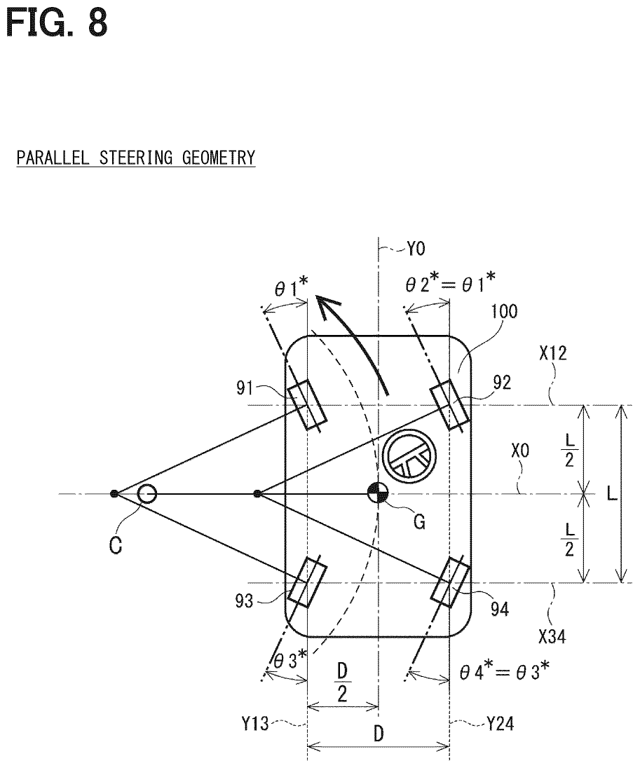

In the above embodiment, the vehicle turning center C is set by the turning-center setting unit 56 so that each wheel 91 to 94 has a turning motion according to Ackermann steering geometry. In other embodiments, for example, as shown in FIG. 8, the vehicle turning center C may be set so that the left and front right wheels 91, 92 and the left and rear right wheels 93, 94 each have a turning motion according to parallel steering geometry. Alternatively, the vehicle turning center C may be set so that a turning motion intermediate between Ackermann steering geometry and the parallel steering geometry is achieved.

In the turning operation according to the parallel steering geometry, the turning angle command value θ21 (θ2*) of the front right wheel 92 is set equal to the turning angle command value θ11 of the front left wheel 91, and the turning angle command value θ41 of the rear right wheel 94 is set equal to the turning angle command value θ31 (θ3*) of the rear left wheel 93. In other words, a turning angle ratio of the turning angle of the wheels on an outside of the turn to the turning angle of the wheels on an inside of the turn is 1.

Not limited to an embodiment in which the turning-center setting unit 56 functions as the “steering angle command value calculator”, the steering angle command value calculator may calculate the turning angle command values θ11 to θ41 for each wheel 91 to 94, regardless of the vehicle turning center C. In that case, the steering angle command value calculator can calculate the turning angle command values θ11 to θ41 for each wheel 91 to 94 individually based on the final steering command value St2 created for each wheel and the three-dimensional map of the vehicle speed V and the steering angle command values. The turning angle command values θ11 to θ41 for each wheel 91 to 94 are calculated by the steering angle command value calculator so that the higher the vehicle speed V is, the more the steering is reduced relative to the final steering command value St2, thereby reduced sudden steering when turning at the high vehicle speed. Thus, driver and passenger discomfort can be avoided.

In the system configuration of FIG. 1, the turning actuator controllers 601 to 604 form a unit with the corresponding turning actuators 71 to 74. Not limited to this configuration, the turning actuator controllers 601 to 604 may be centrally located to control the driving current Ia1 to Ia4 energizing the corresponding turning actuators 71 to 74.

The turning controller of the present disclosure is not limited to four-wheel vehicles, but can also be applied to three-wheel vehicles, or six-wheel or eight-wheel independently steering vehicles having three or more rows of left and right wheel pairs in the longitudinal direction of the vehicle. In summary, the turning controller of the present disclosure is applied to “a vehicle in which three or more wheels that are not mechanically restrained from one another can be steered independently.”

The vehicle 100 may be equipped with only the driver's manually operated steering mechanism 95 as a steering input device, or only the automatic steering command device 96. In such a case, the command value generator 55 does not mediate between the steering angle signal θst and the steering command value St1, but outputs either input as it is as the final steering command value St2. The same is true when either function is temporarily disabled in the vehicle 100 equipped with both the steering mechanism 95 and the steering command device 96.

Each of the wheels 91 to 94 need only be capable of being turned independently and does not have to be driven independently. For example, front wheels 91, 92 may be drive wheels, and rear wheels 93, 94 may be driven wheels.

The present disclosure should not be limited to the embodiment described above. Various other embodiments may be implemented without departing from the scope of the present disclosure.

The control apparatus and the technique according to the present disclosure may be achieved by a dedicated computer provided by constituting a processor and a memory programmed to execute one or more functions embodied by a computer program. Alternatively, the control apparatus and the technique according to the present disclosure may be achieved by a dedicated computer provided by constituting a processor with one or more dedicated hardware logic circuits. Alternatively, the control apparatus and the technique according to the present disclosure may be achieved using one or more dedicated computers constituted by a combination of the processor and the memory programmed to execute one or more functions and the processor with one or more hardware logic circuits. The computer program may be stored in a computer-readable non-transitory tangible storage medium as an instruction executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A turning controller configured to control turning of each wheel in a vehicle equipped with turning actuators that independently steer three or more wheels that are not mechanically coupled to each other and a steering command device for automated driving or a steering mechanism of a steer-by-wire system, which is mechanically separated from the turning actuators, the turning controller comprising:
a generator configured to generate a final steering command value based on a steering angle signal output from the steering mechanism or a steering command value output from the steering command device;
a calculator configured to calculate a turning angle command value for each wheel; and
controllers provided in correspondence with the turning actuators, each of the controllers being configured to control a driving current supplied to a turning actuator of the turning actuators so that the turning angle output by the turning actuator follows the turning angle command value, wherein
the calculator is configured to calculate the turning angle command value for each wheel based on the final steering command value and vehicle speed such that the higher the vehicle speed, the more the turning angle is reduced with respect to the final steering command value.

2. The turning controller according to claim 1, further comprising
a setting unit configured to set a turning center of vehicle turning based on the final steering command value and the vehicle speed, wherein
the setting unit is configured to, as the calculator, calculate the turning angle command value for each wheel so that a turning direction of each wheel is orthogonal to a straight line connecting the turning center and a center of the wheel.

3. The turning controller according to claim 2, wherein
a setting axis is orthogonal to a vehicle longitudinal axis,
a setting distance is between the vehicle longitudinal axis and the turning center, and
the setting unit is configured to:
control the setting distance and set the turning center on the setting axis; and
determine the setting distance using a three-dimensional map which defines relationships between the final steering command value and the setting distance for respective vehicle speeds.

4. The turning controller according to claim 2, wherein
each of setting axes is orthogonal to a vehicle longitudinal axis,
a setting distance is between the vehicle longitudinal axis and the turning center, and
the setting unit is configured to:
control the setting distance and set the turning center on one of the setting axes;
change among the setting axes for setting the turning center in accordance with vehicle speeds; and
determine the setting distance on the changed setting axis using a three-dimensional map which defines relationships between the final steering command value and the setting distance for respective vehicle speeds.

5. The turning controller according to claim 1, wherein
the steering angle signal, the steering command value, and the final steering command value are zero when the vehicle is moving straight ahead and take a positive value or a negative value depending on a steering direction relative to a neutral position, and
the calculator is configured to calculate the turning angle command value for each wheel to maintain the vehicle in a straight-line state in response to an absolute value of the final steering command value being less than a steering lower limit threshold value.

6. A turning controller configured to control turning of each wheel in a vehicle equipped with turning actuators that independently steer three or more wheels that are not mechanically coupled to each other and a steering command device for automated driving or a steering mechanism of a steer-by-wire system, which is mechanically separated from the turning actuators, the turning controller comprising:
at least one processor; and
at least one memory storing computer program code, wherein
the at least one memory and the computer program code are configured, with the at least one processor, to cause the turning controller to carry out:
generating a final steering command value based on a steering angle signal output from the steering mechanism or a steering command value output from the steering command device;
calculating a turning angle command value for each wheel;
controlling a driving current supplied to a turning actuator of the turning actuators so that the turning angle output by the turning actuator follows the turning angle command value; and
calculating the turning angle command value for each wheel based on the final steering command value and vehicle speed such that the higher the vehicle speed, the more the turning angle is reduced with respect to the final steering command value.
